(19) United States
(12) Patent Application Publication
(10) Pub. No.: US 2007/0027824 A1
(43) Pub. Date: Feb. 1, 2007

(54) Handheld device and method for inspecting drain pipes

(76) Inventor: Joseph L. Gibson, Alpharetta, GA (US)

Correspondence Address: THOMPSON & THOMPSON, P.A., P.O BOX 166, SCANDIA, KS, 66966, US

(21) Appl. No.: 11/190,277

(22) Filed: Jul. 26, 2005

(51) Int. Cl. B67D 5/00

(52) U.S. Cl. 705/413

(57) ABSTRACT

A handheld sensor device is disclosed for inspecting a plumbing system. The handheld device has a handheld case, a detection circuit within the case, an acoustic or capacitive sensor, a display, and an audible alarm. The sensor communicates with the detection circuit and is connected to the case by a flexible connector so that the sensor can be easily positioned and held on the exterior surface of a drain pipe. The handheld device provides a visual and/or audible indication of the presence of liquid within the drain pipe. A monitoring system for monitoring drain pipe clogging in a plumbing system is also disclosed. The monitoring system includes a monitoring unit that attaches to a drain pipe using a noninvasive attaching system, such as a hook and loop material. The monitoring system provides a warning and/or controls a shut-off valve when a blockage is detected in the drain pipe.

### BACKGROUND OF THE INVENTION

1. Field of the Invention

The present invention relates generally to handheld sensor devices, plumbing systems, and methods for inspecting drain pipes in plumbing systems.

2. Description of the Related Art

Several techniques exist for determining the presence of a liquid within a closed body, such as a tank or plumbing pipe. Sensor devices are commonly used in industrial applications to maintain or control fluid levels in pipes, tanks, and the like. These devices typically use either acoustic or capacitive sensors and appropriate circuitry and power supply to accomplish this task. These devices are used routinely to activate alarms and/or valves controlling the liquid flow within the industrial process.

New plumbing systems are normally inspected to check for leaks and to ensure system integrity. The inspection process normally includes capping the drain system to prevent drainage and filling the drain pipes with water. The inspector then monitors the level of the liquid within the system, usually at the highest point in the vent used for the system. However, the inspector has no positive means to ensure that all of the drain pipes in the drain system are completely filled, thereby making it difficult to ensure the integrity of the system. Thus, there is a need for a handheld device that can be used by plumbing inspectors to check whether a drain pipe is full of water.

Sewer pipes and other drain pipes often become blocked during usage. In many cases, it is difficult to locate the blockage so that an appropriate method for removing the blockage can be determined. In these cases, a plumber often must resort to a trial-and-error approach until the blockage is located and eliminated. Thus, there is a need for a handheld device that can be used by plumbers to precisely locate a blockage in a drain pipe.

There is also a need for a system that monitors clogging in a drain pipe and emits a warning when clogging occurs, particularly in multi-level plumbing systems. In multi-level drain systems, such as those used in residential and commercial dwellings, clogs can go undetected for a substantial period of time, allowing the system to flood and cause extensive damage.

FIG. 3 shows a conventional multi-level plumbing system 30 to illustrate this problem. As shown in FIG. 3, the drain pipe 31 sometimes becomes clogged at a point 32 below a lower level fixture 33, such as a toilet, allowing the system to overflow through the fixture 33. If no one observes this problem, the water and sewage will continue to overflow out of the fixture 33 until it is detected. This is a problem in all multi-level plumbing systems, especially where the lowest drain is located in a basement or other area that is not frequently observed.

### SUMMARY OF THE INVENTION

It is an object of the present invention to provide a handheld device and method that can be used to determine whether a drain pipe is full of water and/or to locate a blockage in a drain pipe.

It is a further object of the present invention to provide a monitoring system that monitors clogging in a drain pipe and emits a warning or control signal when clogging occurs.

It is a further object of the present invention to provide a monitoring system for plumbing systems that uses a noninvasive attaching means for securing a monitoring unit to a drain pipe.

It is a further object of the present invention to provide a monitoring system for monitoring clogging in a drain pipe, which can be retrofitted easily to existing plumbing systems or plumbing fixtures such as sinks or toilet bowls, and that can be used to signal or control a shut-off valve, a remote alarm, a PC, and/or a central alarm system.

To achieve the foregoing and other objects and in accordance with the purpose of the present invention, as embodied and broadly described herein, the present invention provides a handheld sensor device for inspecting a plumbing system. The handheld device has a handheld case, a detection circuit within the case, an acoustic or capacitive sensor, a display, and an audible alarm. The sensor communicates with the detection circuit and is connected to the case by a flexible connector so that the sensor can be positioned easily and held on the exterior surface of a drain pipe. The handheld device can be used during a plumbing inspection to provide a visual and/or audible indication of the presence of liquid within the drain pipe, and to precisely locate a blockage within the drain pipe.

The present invention also provides a monitoring system for monitoring drain pipe or plumbing fixture clogging in a plumbing system. The monitoring system includes a monitoring unit that attaches to a drain pipe or plumbing fixture using a noninvasive attaching system, such as a hook and loop material. The monitoring system can be arranged to provide an audible and/or visual warning and/or to control a shut-off valve when a blockage is detected in the drain pipe.

According to a broad aspect of the present invention, a handheld device for inspecting a plumbing system is provided, comprising: a handheld case; a detection circuit contained within the handheld case; a sensor in communication with the detection circuit and adapted to be held on the exterior surface of a pipe; and an indicator means in communication with the detection circuit for giving a visual and/or audible indication of the presence of liquid within the pipe.

According to another broad aspect of the present invention, a method of inspecting plumbing systems is provided, comprising the steps of: providing a handheld device comprising a handheld case, a detection circuit contained within the handheld case, a sensor in communication with the detection circuit, and an indicator in communication with the detection circuit; placing the sensor against or near an exterior surface of a drain pipe at a selected location; and determining whether liquid is present within the drain pipe at the selected location based on an output from the indicator.

Additional objects, advantages, and novel features of the invention will be set forth in the following description, and will become apparent to those skilled in the art upon reading this description or practicing the invention. The objects and advantages of the invention may be realized and attained by the appended claims.

### BRIEF DESCRIPTION OF THE DRAWINGS

The present invention will become more clearly appreciated as the disclosure of the present invention is made with reference to the accompanying drawings.

In the drawings:

FIG. 1 is a perspective view of a handheld sensor device for inspecting a plumbing system according to a first embodiment of the present invention.

FIG. 2 is a schematic diagram of the components of the handheld sensor device shown in FIG. 1.

FIG. 3 is a cross section elevation view of a conventional multi-level plumbing system with a clogged drain pipe.

FIG. 4 is a cross section elevation view of a multi-level plumbing system equipped with a monitoring unit for monitoring clogging in the drain pipe or plumbing fixture according to the present invention.

FIG. 5 is a perspective view of the monitoring unit shown in FIG. 4.

FIG. 6 is a schematic diagram of a monitoring system for monitoring clogging in a drain pipe according to the present invention.

### DETAILED DESCRIPTION OF THE INVENTION

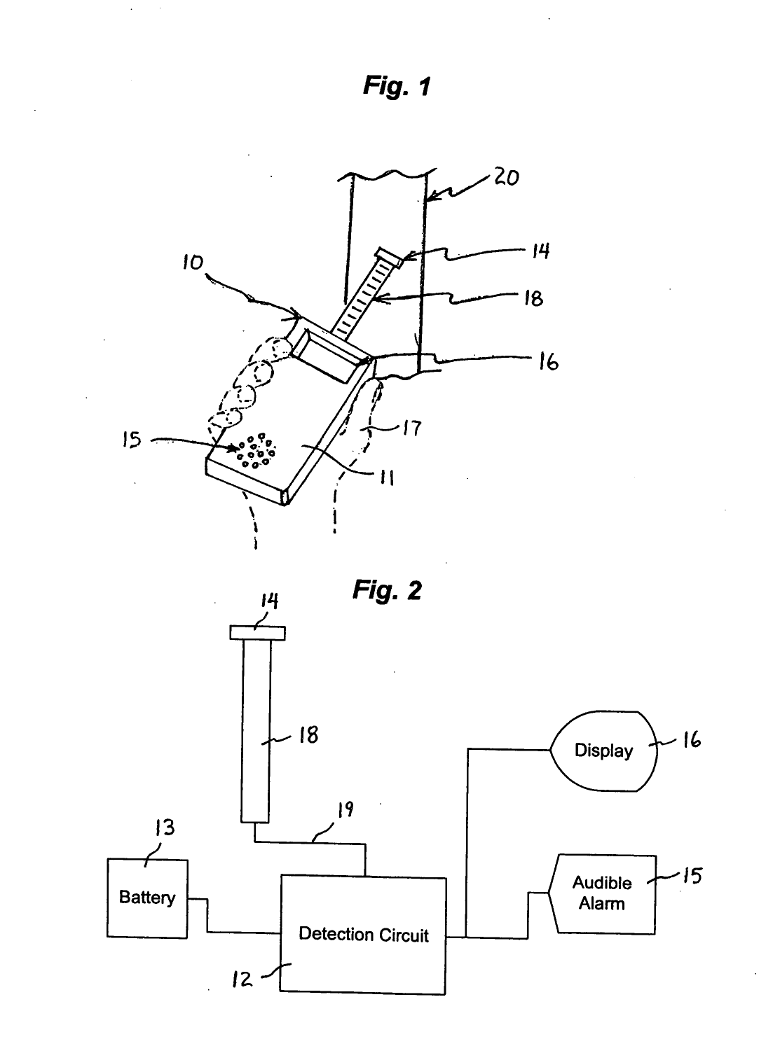

A handheld sensor device 10 for inspecting a plumbing system according to the present invention will be described in detail hereinafter with reference to FIGS. 1 and 2 of the accompanying drawings.

The handheld device 10 includes a handheld case 11, a detection circuit 12 contained within the handheld case 11, a battery 13 that provides a power supply for the detection circuit 12, a sensor 14, and an indicator means 15, 16. The handheld case 11 is preferably sized to fit comfortably in a user's hand 17. A variety of shapes, sizes, and configurations can be used to give the case 11 a desired look and feel. The case 11 is preferably made of a plastic material, but other suitable materials could be used instead.

The sensor 14 can be an acoustic sensor or a capacitive sensor, both of which are known in the art. The sensor 14 is preferably connected to the handheld case 11 by a flexible connector member 18 that allows the sensor 14 to be moved relative to the handheld case 11. A conductor 19 is contained within the flexible connector member 18 for communicating with the detection circuit 12. The sensor 14 can be placed against or near an exterior surface of a drain pipe 20 at a selected location by holding the handheld case 11 at a comfortable position and moving the sensor 14 to the desired location.

The indicator means includes an audible alarm 15 built into the handheld case 11, and a visual display 16 on the handheld case 11. The visual display 16 can be, for example, a liquid crystal display (LCD). Both the audible alarm 15 and the visual display 16 are connected to and activated by the detection circuit 12. The alarm 15 and display 16 are used to give an audible and visual indication to the user of the presence of liquid within the drain pipe 20.

In use, the sensor 14 is placed against or near an exterior surface of a drain pipe 20 at a selected location. The output from the sensor 14 is processed by the detection circuit 12 to determine whether the output is consistent with a drain pipe containing liquid or a drain pipe containing air. If the drain pipe 20 contains liquid, the detection circuit 12 communicates a signal to the visual display 16 and the audible alarm 15, which are activated to alert the user that liquid is present within the drain pipe 20 at the selected location. The user can either listen for an output from the audible alarm 15, or observe the message on the visual display 16.

The handheld device 10 can be used to perform a variety of useful functions. For example, the handheld device 10 can be used to pinpoint the location of a blockage in a clogged drain pipe 20. This can be accomplished by placing the sensor 14 against or near the exterior surface of the drain pipe 20 at multiple locations until the blockage is precisely located (the drain pipe 20 will be full of liquid upstream of the blockage and will contain air immediately downstream of the blockage).

The handheld device 10 is also useful for inspecting new plumbing systems. The drain pipes of the plumbing system can be filled with water according to normal inspection procedures. The sensor 14 of the handheld device 10 can then be placed against or near the exterior surface of the drain pipes at multiple locations to ensure that water is present at all desired points within the plumbing system during the inspection.

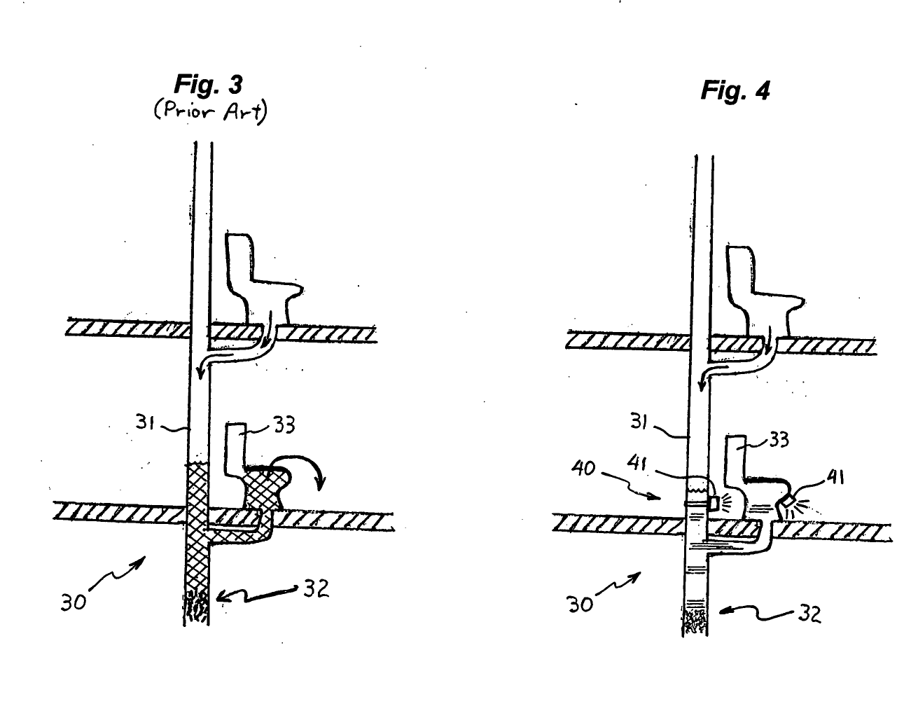

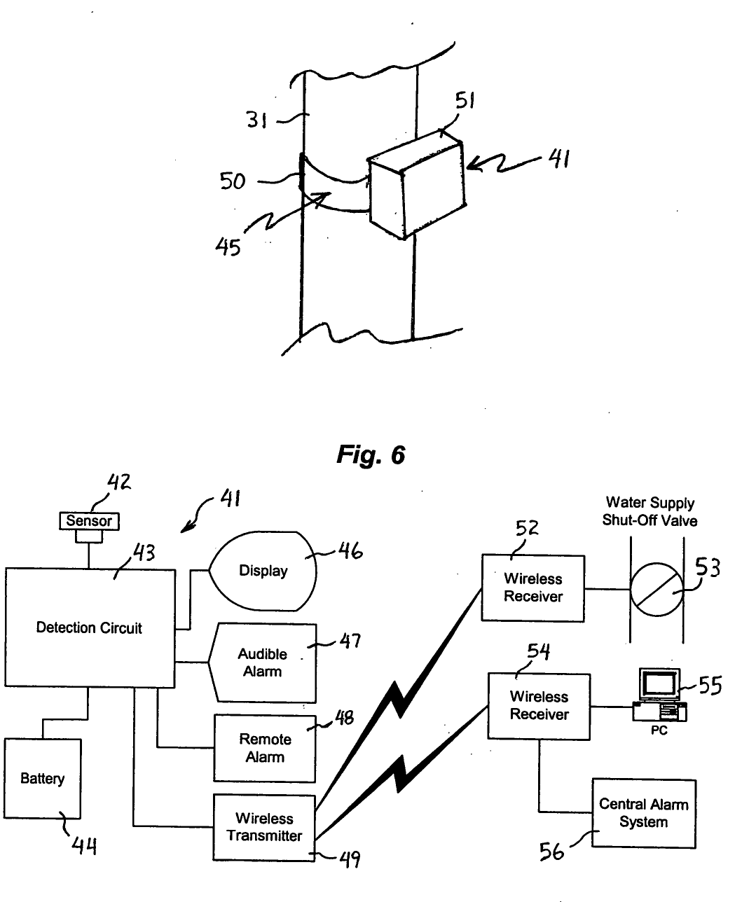

A monitoring system 40 for monitoring clogging in a drain pipe or plumbing fixture of a plumbing system 30 according to the present invention will now be described with reference to FIGS. 4 to 6 of the accompanying drawings. The same reference numerals are used in FIG. 4 to label the components of the plumbing system 30, as previously described above in connection with FIG. 3.

The monitoring system 40 includes a monitoring unit 41 having a sensor 42, a detection circuit 43, a battery 44 for a power supply for the detection circuit 43, an attaching means 45, and an alarm means 46-49. As with the handheld sensor device 10 described. above, the sensor 42 of the monitoring unit 41 can be, for example, an acoustic sensor or a capacitive sensor.

The attaching means 45 is used to attach the monitoring unit 41 to a drain pipe 31 to be monitored, such as a sewer/drain pipe in a multi-level plumbing system 30, or a plumbing fixture 33. In the preferred embodiment, the attaching means 45 is a fabric strap 50 secured to the housing 51 of the monitoring unit 41. The fabric strap 50 preferably has a hook and loop fastening material fastened to its respective ends. The fabric strap 50 can be wrapped around the drain pipe 31 and the hook and loop fastening material on the respective ends of the fabric strap 50 mated together to attach the monitoring unit 41 to the drain pipe 31.

Other attaching systems can also be used to attach the monitoring unit 41 to the drain pipe 31 or plumbing fixture 33. For example, an adhesive can be used to bond the monitoring unit 41 to the drain pipe 31, or a hook and loop fastening material can be secured directly to the external surface of the drain pipe 31 or plumbing fixture 33 and the housing 51 of the monitoring unit 41. The attaching means used will preferably be a non-invasive attaching system that does not penetrate into the wall of the drain pipe 31 or plumbing fixture 33.

The alarm means 46-49 of the monitoring unit 41 is connected to the detection circuit 43 for giving a visual and/or audible warning when the monitoring unit 41 detects a blockage 32 in the drain pipe 31. In the preferred embodiment, the alarm means includes an audible alarm 47 and a visual display 46 on the monitoring unit 41. The alarm means also includes a remote alarm 48 in the form of an audible alarm and/or a visual display positioned at a remote location from the monitoring unit 41. The remote alarm 48 can be connected by a wire to the detection circuit, or a wireless transmitter can be used to communicate control signals to the remote alarm 48.

A wireless transmitter 49 can also be used to communicate control signals to a wireless receiver 52 connected to a water shut-off valve 53 for the plumbing system, or to a wireless receiver 54 connected to a PC 55 for sending warnings, e.g., by E-mail, to alert an appropriate party of the clogged drain pipe 31, or to a wireless receiver 54 connected to a central alarm/monitoring system 56.

In a preferred embodiment of the monitoring system 40, the detection circuit 43 will provide intermittent monitoring of the output of the sensor 42 (e.g., one reading every 1 to 3 minutes). Such intermittent monitoring will conserve power and thereby increase the life of the battery 44. The detection circuit 43 can also incorporate some basic control logic to reduce the possibility of false alarms. For example, the control logic of the detection circuit 43 can be set to require more than one (e.g., three) consecutive positive readings indicating the drain pipe is full before the alarm means 46-49 is activated to warn of a plugged pipe. Such control logic will help eliminate false readings caused by a full drain pipe during normal functioning of the plumbing system (e.g., while flushing a toilet or draining a bathtub).

In an alternative embodiment, the detection circuit 43 can be made to provide a continuous monitoring of the output of the sensor 42, and a timer can be used to limit activation of the alarm means 46-49 to those instances when the sensor detects a full drain pipe for more than a predetermined time period (e.g., 5 to 10 minutes).

The detection circuit 43 can also be equipped with a sensor to detect when the charge in the battery 44 falls below a predetermined level. When a low battery is detected, the detection circuit 43 can then activate the alarm means 46-49 to provide a suitable warning to the user to ensure that the battery 44 is replaced before it loses its charge completely. Similar low battery alarms are used, for example, on smoke detectors.

In use, the monitoring unit 41 can be attached to a drain pipe 31 or plumbing fixture 33 of a plumbing system 30, as shown in FIG. 4. The monitoring unit 41 can be positioned at a location along the drain pipe 31 that will provide an alarm whenever the drain pipe 31 is clogged, and particularly a drain pipe 31 that would tend to overflow a fixture 33 of the plumbing system 30. Alternatively, the monitoring unit 41 can be positioned at a location on the plumbing fixture 33 that will provide an alarm whenever the drain pipe 31 is clogged, or whenever the fixture 33 itself is clogged. The monitoring unit 41 can then be used to monitor (continuously or intermittently) whether liquid is present in the drain pipe 31 or the plumbing fixture 33 that would indicate a clogging of the drain pipe 31 or the plumbing fixture 33. If a drain pipe or plumbing fixture clogging is determined by the sensor 42 and detection circuit 43 of the monitoring unit 41, the detection circuit 43 activates the alarm means 46-49 to give a visual and/or audible warning of the clogging. The detection circuit 43 can also be used to activate a water shut-off valve 53 to shut off the water supply to the plumbing system 30, or to send an appropriate message through a PC 55 or central alarm/monitoring system 56.

While the invention has been specifically described in connection with specific embodiments thereof, it is to be understood that this is by way of illustration and not of limitation, and the scope of the appended claims should be construed as broadly as the prior art will permit.

What is claimed is:

1. A handheld device for inspecting a plumbing system, comprising:
a handheld case;
a detection circuit contained within the handheld case;
a sensor in communication with the detection circuit and adapted to be held on the exterior surface of a pipe; and
an indicator means in communication with the detection circuit for giving a visual and/or audible indication of the presence of liquid within the pipe.

2. The handheld device according to claim 1, wherein said sensor is an acoustic sensor.

3. The handheld device according to claim 1, wherein said sensor is a capacitive sensor.

4. The handheld device according to claim 1, wherein said indicator means comprises an audible alarm built into the handheld case.

5. The handheld device according to claim 1, wherein said indicator means comprises a visual display on the handheld case.

6. The handheld device according to claim 1, wherein said sensor is connected to the detection circuit by a flexible connector member that allows the sensor to be moved relative to the handheld case.

7. The handheld device according to claim 1, further comprising a battery contained within said handheld case for providing a power supply to said detection circuit.

8. The handheld device according to claim 1, wherein said handheld case is sized to fit comfortably within a user's hand.

9. The handheld device according to claim 1, wherein said detection circuit comprises a means for processing an output from the sensor to determine if the output is consistent with a drain pipe containing liquid, and causing said indicator means to give a visual and/or audible indication of the presence of liquid within the drain pipe.

10. A method of inspecting plumbing systems, comprising the steps of:
providing a handheld device comprising a handheld case, a detection circuit contained within the handheld case, a sensor in communication with the detection circuit, and an indicator in communication with the detection circuit;
placing the sensor against or near an exterior surface of a drain pipe at a selected location; and
determining whether liquid is present within the drain pipe at the selected location based on an output from the indicator.

11. The method according to claim 10, wherein the indicator comprises an audible alarm, and said step of determining whether liquid is present comprises listening for an output from said audible alarm.

12. The method according to claim 10, wherein the indicator comprises a visual display, and said step of determining whether liquid is present comprises observing changes in the visual display.

13. The method according to claim 10, wherein said step of placing the sensor comprises placing the sensor against or near an exterior surface of a drain pipe at multiple locations to precisely locate a blockage in the drain pipe.

14. The method according to claim 10, further comprising the steps of filling a plumbing system to be inspected with water, and placing the sensor against or near an exterior surface of drain pipes in the plumbing system at multiple locations to ensure that water is present in all desired points within the plumbing system during the inspection.
